(19) United States
(12) Patent Application Publication
(10) Pub. No.: US 2018/0107320 A1
(43) Pub. Date: Apr. 19, 2018

(54) CENTER FASCIA AND CONTROLLING METHOD THEREOF

(71) Applicant: LG ELECTRONICS INC., Seoul (KR)

(72) Inventors: Hyeongjin IM, Seoul (KR); Hyorim PARK, Seoul (KR); Seijun LIM, Seoul (KR); Eunju LEE, Seoul (KR); Chulbae LEE, Seoul (KR)

(21) Appl. No.: 15/300,341

(22) PCT Filed: Dec. 3, 2015
(86) PCT No.: PCT/KR2015/013139

§ 371 Date: Sep. 29, 2016

Related U.S. Application Data
(60) Provisional application No. 62/158,552, filed on May 8, 2015.

(51) Int. Cl. G06F 3/041; B60K 35/00; B60Q 9/00; G06F 3/0482

(52) U.S. Cl. CPC G06F 3/0414; B60K 35/00; B60Q 9/00; G06F 3/0416; G06F 3/0482; B60K 2350/925; B60K 2350/352; B60K 2350/1016; B60K 2350/102; B60K 2350/1032; B60K 2350/104; B60K 2350/1028

(57) ABSTRACT

A center fascia and controlling method thereof are disclosed. The present invention includes receiving a user input from a user through an interface module and differently displaying a screen in accordance with at least one of a location of the interface module, a direction faced by a specific portion of the interface module and a touch input to the interface module.

### TECHNICAL FIELD

The present invention relates to a center fascia, and more particularly, to a center fascia and controlling method thereof. Although the present invention is suitable for a wide scope of applications, it is particularly suitable for providing a user with a display screen of enhanced performance and a user interface of enhanced performance by running a specific function corresponding to a location of an interface module in a manner of adjusting a location of the interface module and a specific part (e.g., knob) of the interface module.

### BACKGROUND ART

Recently, a center fascia is rising as a big issue in daily life owing to the ongoing developments of the IT technology. The center fascia means a center part of a dashboard that separates a room and an engine part of a car from each other. In particular, the center fascia means a space in which devices of various function gather between a driver seat and a passenger seat of the car. Devices for a navigation system, a multimedia player, an air conditioner, a car gear state, a car system and the like are situated in this space.

Particularly, as a center fascia provides various car data and multimedia data nowadays, it is popularly used as a tool for enhancing user's convenience and entertaining a user.

However, a center fascia of a related art has stationary space zones for navigation system, a multimedia player, a video player, an air conditioner, a car gear state, a car system and the like.

Due to the stationary space zones, it is unable to adjust the space zones as necessary for a user, thereby causing inconvenience to the user.

### DISCLOSURE OF THE INVENTION

### Technical Tasks

Accordingly, the present invention is directed to a center fascia and controlling method thereof that substantially obviate one or more of the problems due to limitations and disadvantages of the related art.

One object of the present invention is to provide a center fascia and controlling method thereof, by which a display screen optimized for a user can be embodied by displaying a content corresponding to a location in accordance with a location of an interface module and a control direction of a knob on a screen and then running a specific function of a content corresponding to the interface module.

Another object of the present invention is to provide a center fascia and controlling method thereof, by which an image displayed above an interface module is adjusted in accordance with a property of a displayed content and by which a touch input function of the interface module can be activated.

Further object of the present invention is to provide a center fascia and controlling method thereof, by which a shape of an interface module, a location of the interface module and a screen corresponding to the interface module are displayed differently in accordance with a speed of a center fascia installed car.

Another further object of the present invention is to provide a center fascia and controlling method thereof, by which a moving speed of an interface module is differentiated in accordance with a direction faced by a specific portion of an interface module and a moving direction of the interface module.

Technical tasks obtainable from the present invention are non-limited by the above-mentioned technical tasks. And, other unmentioned technical tasks can be clearly understood from the following description by those having ordinary skill in the technical field to which the present invention pertains.

### Technical Solution

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a center fascia according to one embodiment of the present invention includes an interface module configured to receive a user input from a user, a controller differently displaying a screen in accordance with at least one selected from the group consisting of a location of the interface module, a direction faced by a specific portion of the interface module and a touch input to the interface module, and a display module configured to display the screen in accordance with a control command from the controller, wherein if receiving an input of moving the interface module in a 1^{st} direction from the user, the controller moves a category of the screen from a 1^{st} category to a 2^{nd} category different from the 1^{st} category, wherein if receiving a user input of moving the specific portion of the interface module in a 2^{nd} direction from the user, the controller moves a menu of the category to either a submenu or a supermenu, wherein if receiving a user input of moving the specific portion of the interface module in a 3^{rd} direction from the user, the controller moves the menu from a 1^{st} menu to a 2^{nd} menu different from the 1^{st} menu, and wherein if receiving an input of pushing the interface module from the user, the controller launches a specific function of the menu.

To further achieve these and other advantages and in accordance with the purpose of the present invention, as embodied and broadly described, a method of controlling a center fascia according to another embodiment of the present invention includes the steps of receiving a user input from a user through an interface module and differently displaying a screen in accordance with at least one selected from the group consisting of a location of the interface module, a direction faced by a specific portion of the interface module and a touch input to the interface module, wherein if receiving an input of moving the interface module in a 1^{st} direction from the user, a category of the screen is moved from a 1^{st} category to a 2^{nd} category different from the 1^{st} category, wherein if receiving a user input of moving the specific portion of the interface module in a 2^{nd} direction from the user, a menu of the category is moved to either a submenu or a supermenu, wherein if receiving a user input of moving the specific portion of the interface module in a 3^{rd} direction from the user, the menu is moved from a 1^{st} menu to a 2^{nd} menu different from the 1^{st} menu, and wherein if receiving an input of pushing the interface module from the user, a specific function of the menu is launched.

It is to be understood that both the foregoing general description and the following detailed description are exemplary and explanatory and are intended to provide further explanation of the invention as claimed.

### Advantageous Effects

Accordingly, the present invention provides the following effects and/or features.

First of all, according to one embodiment of the present invention, a display screen optimized for a user can be embodied by displaying a content corresponding to a location in accordance with a location of an interface module and a control direction of a knob on a screen and then running a specific function of a content corresponding to the interface module, thereby enhancing user's convenience.

Secondly, according to another embodiment of the present invention, an image displayed above an interface module is adjusted in accordance with a property of a displayed content and a touch input function of the interface module can be activated, thereby enhancing user's convenience.

Thirdly, according to further embodiment of the present invention, a shape of an interface module, a location of the interface module and a screen corresponding to the interface module are displayed differently in accordance with a speed of a center fascia installed car, thereby enhancing user's convenience.

Fourthly, according to another further embodiment of the present invention, a moving speed of an interface module is differentiated in accordance with a direction faced by a specific portion of an interface module and a moving direction of the interface module, thereby enhancing user's convenience.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention. The above and other aspects, features, and advantages of the present invention will become more apparent upon consideration of the following description of preferred embodiments, taken in conjunction with the accompanying drawing figures.

In the drawings:

FIG. 1 is a block diagram of a center fascia according to one embodiment of the present invention;

FIG. 2 is a flowchart of a center fascia controlling method according to one embodiment of the present invention;

FIG. 3 is a diagram of a center fascia installed in a car according to one embodiment of the present invention;

FIG. 4A and FIG. 4B are diagrams to describe basic operations of an interface module and such a specific portion of the interface module as a knob according to one embodiment of the present invention;

FIG. 5 is a diagram to describe an operation of adjusting an image displayed above an interface module in accordance with a property of a displayed content according to one embodiment of the present invention;

FIG. 6 is a diagram to describe an operation of activating a touch input function of an interface module in accordance with a property of a displayed content according to one embodiment of the present invention;

FIG. 7 is a diagram to describe an operation of displaying a screen by changing a size of a current screen region in case of moving in a 1^{st} direction while pushing an interface module according to one embodiment of the present invention;

FIG. 8 is a diagram to describe an operation of generating a haptic feedback, if an interface module is located in a prescribed distance from a specific location of a specific indicator, according to one embodiment of the present invention;

FIG. 9 is a diagram to describe an operation of generating a haptic feedback, if an interface module is located in a prescribed distance from a specific location of a specific indicator, according to one embodiment of the present invention;

FIG. 10 is a diagram to describe an operation of differently changing a shape of a knob in accordance with a speed of a center fascia installed car according to one embodiment of the present invention;

FIG. 11 is a diagram to describe an operation of differently changing a location of an interface module and a screen corresponding to the interface module in accordance with a speed of a center fascia installed car according to one embodiment of the present invention;

FIG. 12 is a diagram to describe an operation of automatically returning an interface module to an original location in case of starting an engine of a car according to one embodiment of the present invention;

FIG. 13 is a diagram to describe an operation of differentiating a moving speed in case of moving an interface module up/down in accordance with a direction of a knob according to one embodiment of the present invention;

FIG. 14 is a diagram to describe an operation of differentiating a moving speed in case of moving an interface module up/down in accordance with a direction of a knob according to one embodiment of the present invention;

FIG. 15 is a diagram to describe a case of changing a content by tilting a knob up/down according to one embodiment of the present invention;

FIG. 16 is a diagram to describe a case that a content size is different in case of changing a content by tilting a knob up/down according to one embodiment of the present invention;

FIG. 17 is a diagram to describe a case of controlling a specific content corresponding to a location of an interface module in accordance with a movement of a specific portion of the interface module according to one embodiment of the present invention;

FIG. 18 is a diagram to describe an operation of controlling a sliding speed of a knob in accordance with a car speed according to one embodiment of the present invention;

FIG. 19 is a diagram to describe an operation of arranging contents differently in accordance with a mode according to one embodiment of the present invention;

FIG. 20 is a diagram to describe an operation of arranging contents differently in accordance with a car speed and a mode according to one embodiment of the present invention;

FIG. 21 is a diagram to describe an operation of when a knob is situated at the end of a display region, if an additional content exists in case of tilting the knob in an edge direction, displaying the additional content on a screen according to one embodiment of the present invention;

FIG. 22 is a diagram to describe an operation for a display module to display a different screen in accordance with a location of an interface module according to one embodiment of the present invention;

FIG. 23 is a diagram if screens displayed by a center fascia, a cluster and a head-up display according to one embodiment of the present invention;

FIG. 24 is a diagram to describe operating functions of an interface module and a specific portion of a knob of the interface module according to one embodiment of the present invention;

FIG. 25 is a diagram to describe an operation for a display module to display a different screen in accordance with a location of an interface module according to one embodiment of the present invention;

FIG. 26 is a diagram to describe an operation for a display module to display a different screen in accordance with a location of an interface module according to one embodiment of the present invention;

FIG. 27 is a diagram to describe an operation for a display module to display a different screen in accordance with a location of an interface module according to one embodiment of the present invention;

FIG. 28 is a diagram to describe an operation for a display module to display a different screen in accordance with a location of an interface module according to one embodiment of the present invention; and

FIG. 29 is a diagram to describe a function activated in accordance with a location of an interface module according to one embodiment of the present invention.

### BEST MODE FOR INVENTION

Reference will now be made in detail to the preferred embodiments of the present invention, examples of which are illustrated in the accompanying drawings, to facilitate those having ordinary skill in the art to implement the invention. Wherever possible, the same reference numbers will be used throughout the drawings to refer to the same or like parts. Terminologies ‘module’ and ‘unit’ for components used in the following description are interchangeably usable in consideration of the facilitation for the specification writing but do not have distinctive meanings or roles.

In describing embodiments disclosed in the present specification, if the details of the related art are determined as obscuring the gist of the embodiments disclosed in the present specification, the corresponding detailed description shall be omitted.

The accompanying drawings are included to provide a further understanding of the invention, are incorporated in and constitute a part of this specification, and illustrate embodiments of the invention and together with the description serve to explain the principles of the invention. And, the accompanying drawings should be understood as including various modifications and variations of the invention that come within the scope of the appended claims and their equivalents.

Terminologies including ordinal numbers such as 1^{st}, 2^{nd} and the like may be used to describe various components, by which the components may be non-limited. And, the terminologies are used for the purpose of discriminating one component from other components only.

If one component is mentioned as ‘connected to’ or ‘accessing’ another component, the former component may be connected to accesses the latter component in direct. Yet, it is understood that a different component may be present in-between. On the other hand, if one component is mentioned as ‘directly connected to’ or ‘directly accessing’ another component, it is understood that a different component may is not present in-between.

Singular expression may include plural expressions unless having a clear meaning in the context.

In the present application, such a terminology as ‘include’, ‘have’ and the like intends to designate that a feature, a number, a step, an operation, a component, a part or a combination thereof disclosed in the specification exists and should be understood as not excluding possibility of existence or addition of at least one or more features, numbers, steps, operations, components, parts or combinations thereof

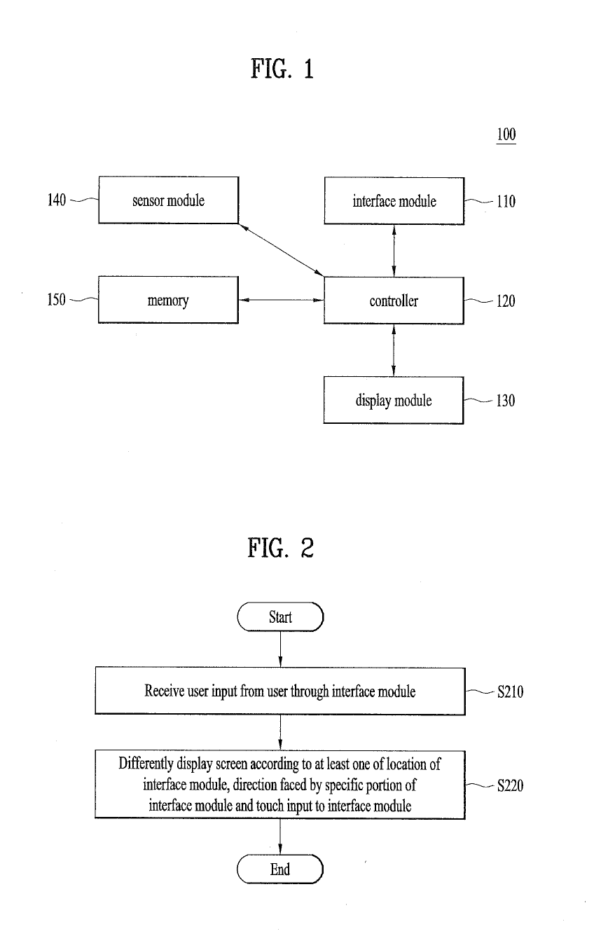

FIG. 1 is a block diagram of a center fascia according to one embodiment of the present invention.

Referring to FIG. 1, a center fascia 100 may include an interface module 110, a controller 120, a display module 130, a sensor module 140 and a memory 150.

The interface module 110 receives a user input from a user.

The controller 120 displays a screen differently in accordance with at least one of a location of the interface module 110, a direction faced by a specific portion of the interface module 110, and a touch input to the interface module 110.

If an input of moving the interface module 110 in a 1^{st} direction is received from the user, the controller 120 moves a category of a screen from a 1^{st} category to a 2^{nd} category different from the 1^{st} category. If a user input of moving the specific portion of the interface module 110 in a 2^{nd} direction is received from the user, the controller 120 moves a menu to a submenu or a supermenu. If a user input of moving the specific portion of the interface module 110 in a 3^{rd} direction is received from the user, the controller 120 moves a menu from a 1^{st} menu to a 2^{nd} menu different from the 1^{st} menu. If an input of pushing the interface module 110 is received from the user, the controller launches a specific function of a menu. The controller 120 adjusts an image displayed on the interface module 110 in accordance with a property of a displayed content.

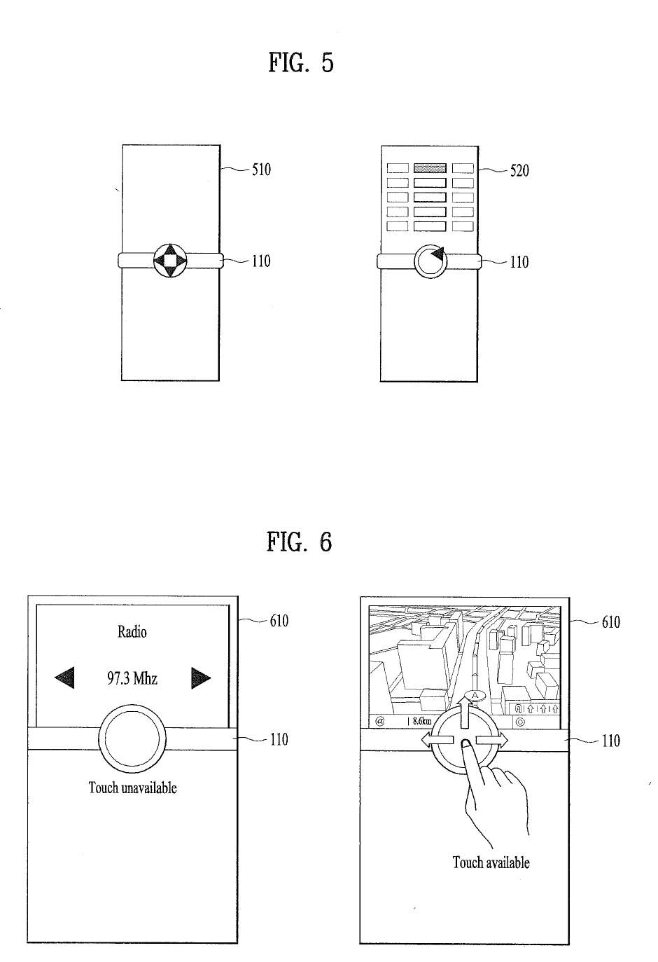

This will be described in detail with reference to FIG. 5 later.

The controller 120 activates a touch input function of the interface module 110 in accordance with a property of a displayed content.

This will be described in detail with reference to FIG. 6 later.

If the interface module 110 is moved in the 1^{st} direction while pushed, the controller 120 changes a size of a current screen region and the displays the size-changed screen.

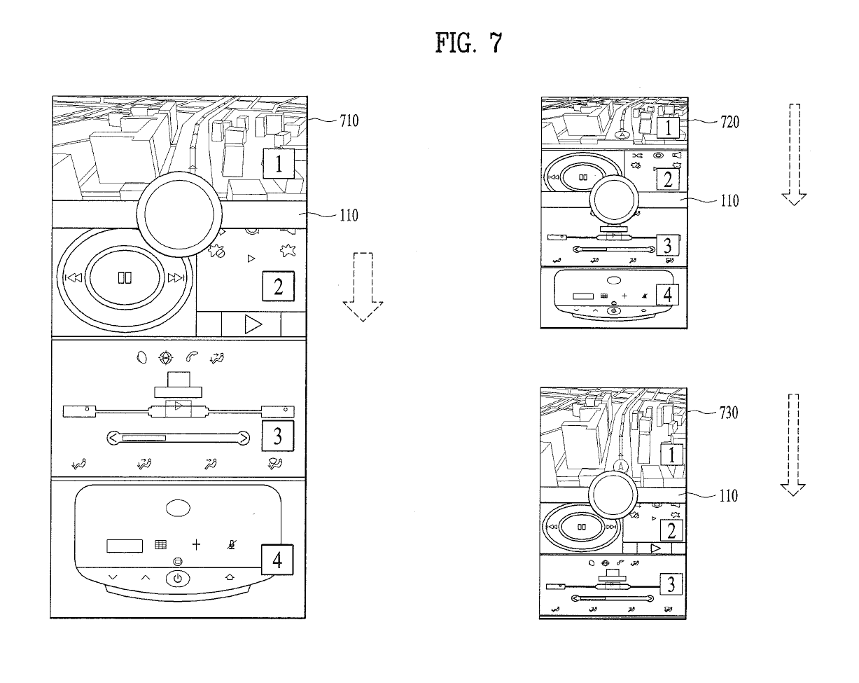

This will be described in detail with reference to FIG. 7 later.

If the interface module 110 is located within a prescribed distance from a specific location at which a specific indicator is located, the controller 120 generates a haptic feedback.

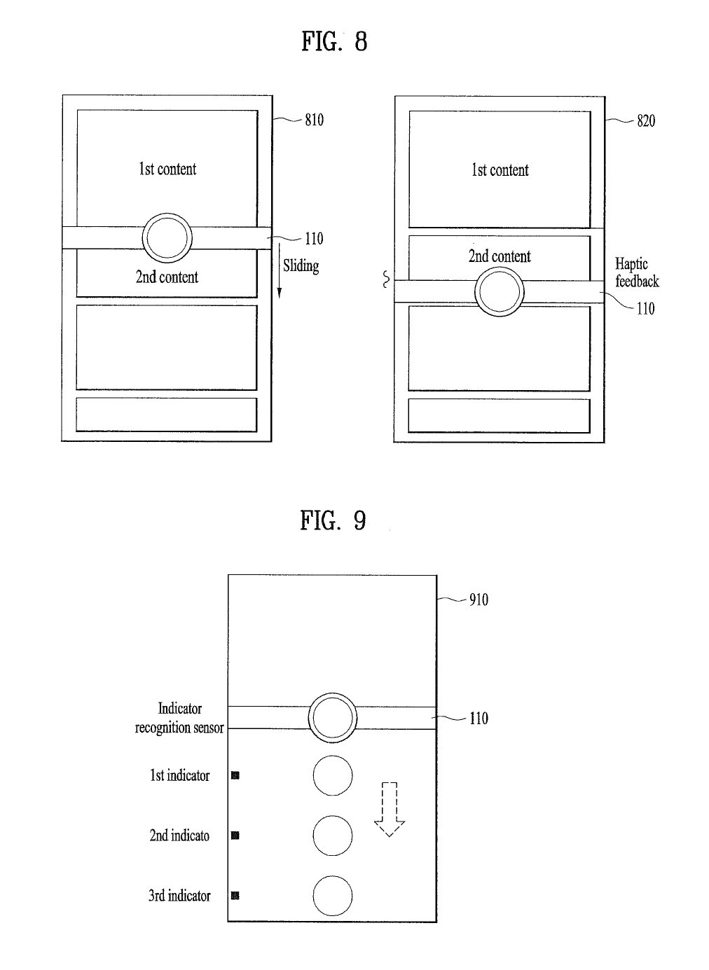

This will be described in detail with reference to FIG. 8 and FIG. 9 later.

The controller 120 changes a shape of the interface module 110 differently in accordance with a speed of the center fascia installed car.

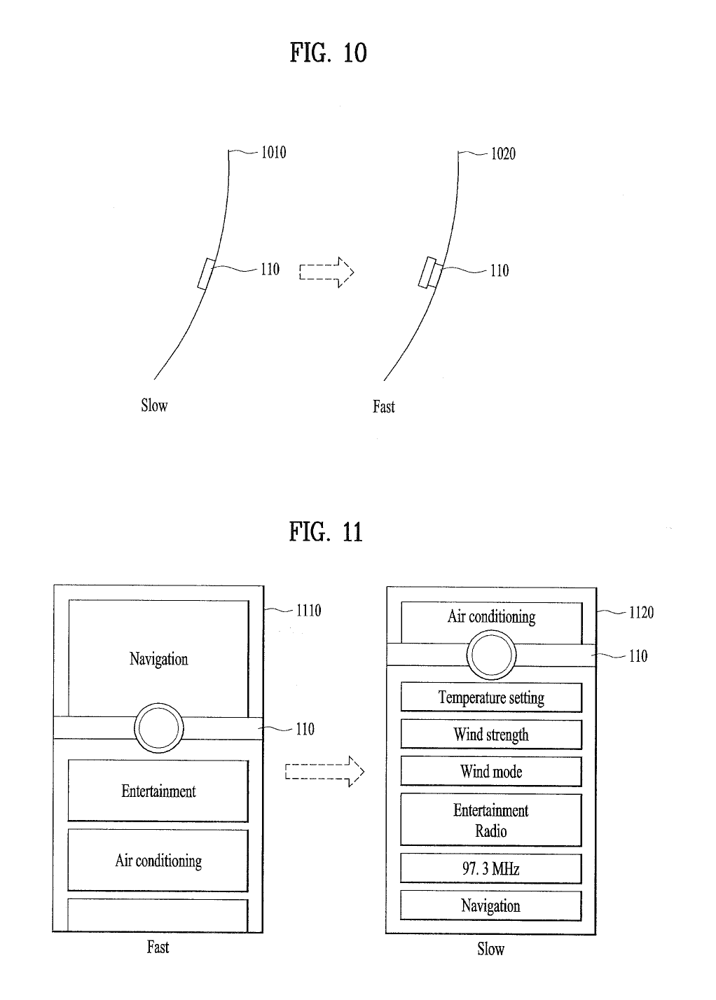

This will be described in detail with reference to FIG. 10 later.

The controller 120 differentiates a location of the interface module 110 and a screen corresponding to the interface module 110 in accordance with a speed of the center fascia installed car.

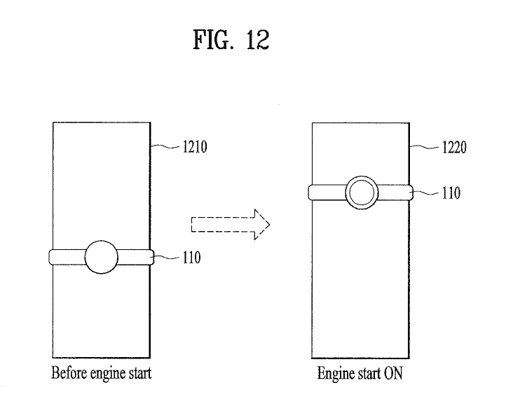

This will be described in detail with reference to FIG. 11 later.

If an engine start of the center fascia installed car is activated, the controller 120 moves the interface module 110 to a preset specific location.

This will be described in detail with reference to FIG. 12 later.

The controller 120 differentiates a moving speed of the interface module 110 in accordance with a direction faced by a specific portion of the interface module 110 and a moving direction of the interface module 110.

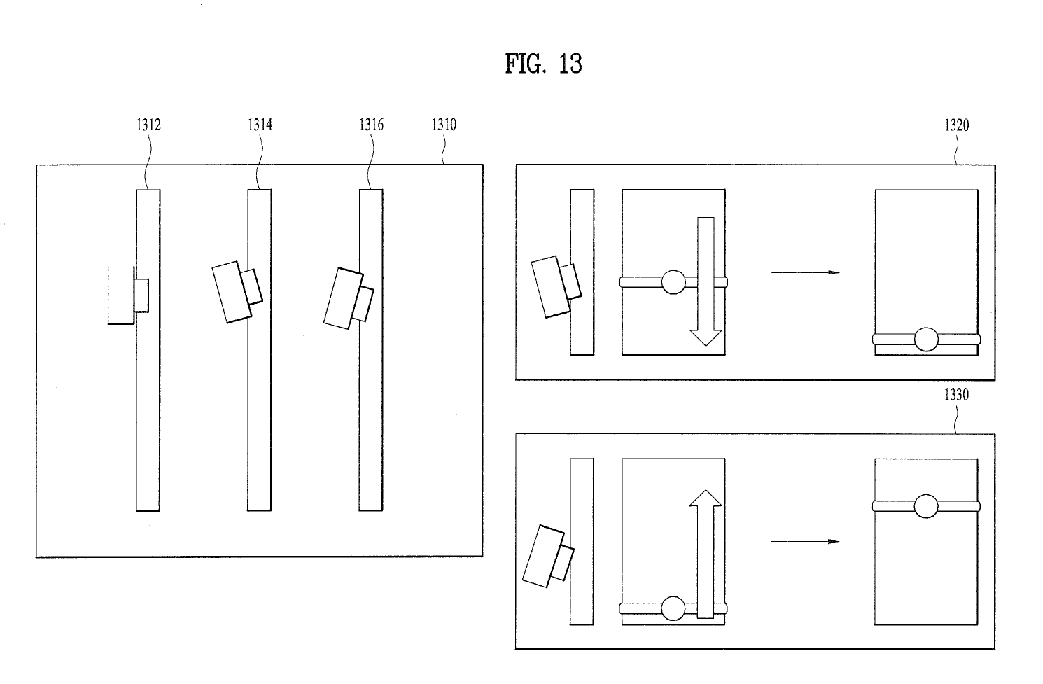

This will be described in detail with reference to FIG. 13 later.

If a direction faced by a specific portion of the interface module 110 is equal to a moving direction of the interface module 110, the controller 120 moves the interface module 110 directly without holding in a 1^{st} direction.

This will be described in detail with reference to FIG. 13 later.

If a direction faced by a specific portion of the interface module 110 is different from a moving direction of the interface module 110, the controller 120 moves the interface module 110 at a speed slower than a reference value.

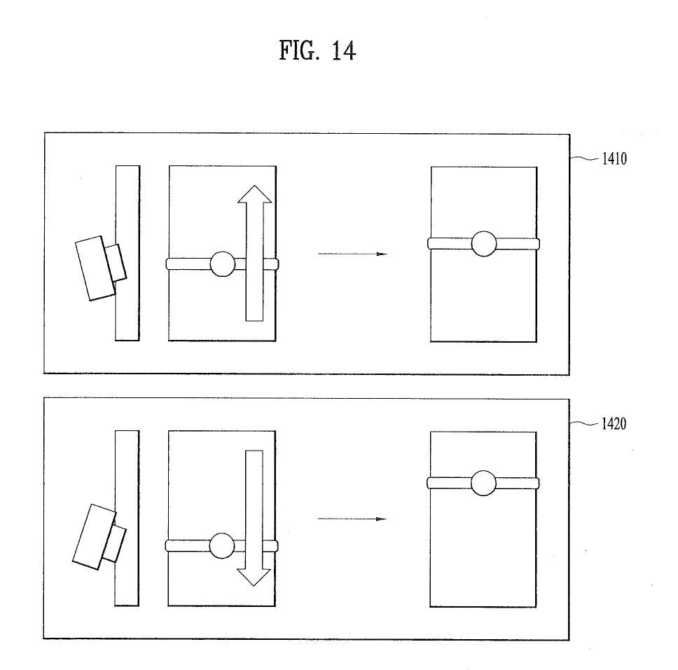

This will be described in detail with reference to FIG. 14 later.

If a user input for a specific portion of the interface module to face a downward direction in a current state is received from a user, the controller 120 controls a content located above the interface module 110 to be displayed below the interface module 110 with reference to the interface module 110.

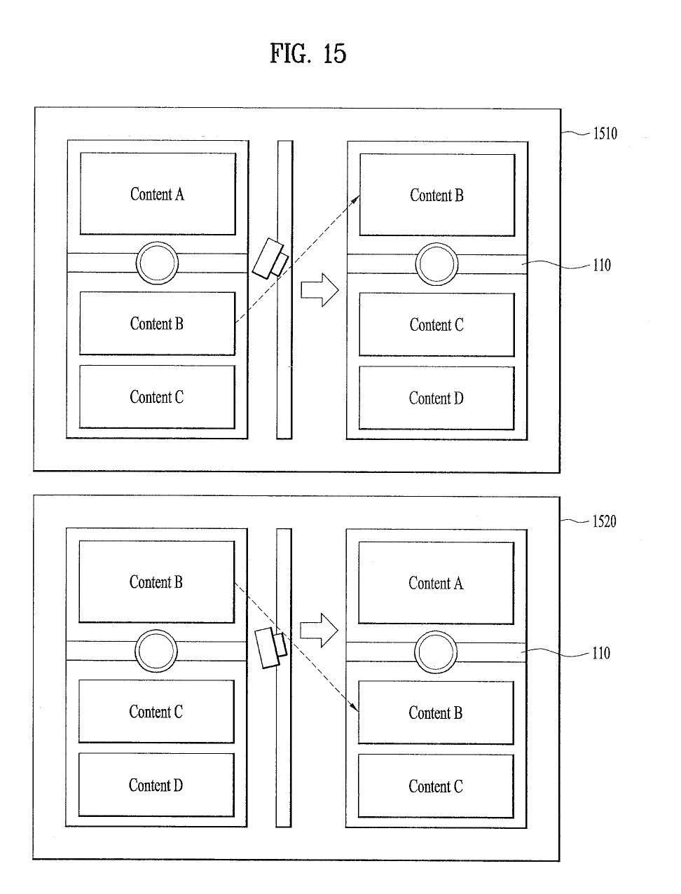

This will be described in detail with reference to FIG. 15 later.

If a user input for a specific portion of the interface module to face an upward direction in a current state is received from a user, the controller 120 controls a content located below the interface module 110 to be displayed above the interface module 110 with reference to the interface module 110.

This will be described in detail with reference to FIG. 15 later.

After a user input for a specific portion of the interface module to face a specific direction in a current state has been received from a user, if the input is released, the controller 120 adjusts a size of a screen region corresponding to a specific content and then displays a screen region corresponding to the size adjusted specific content.

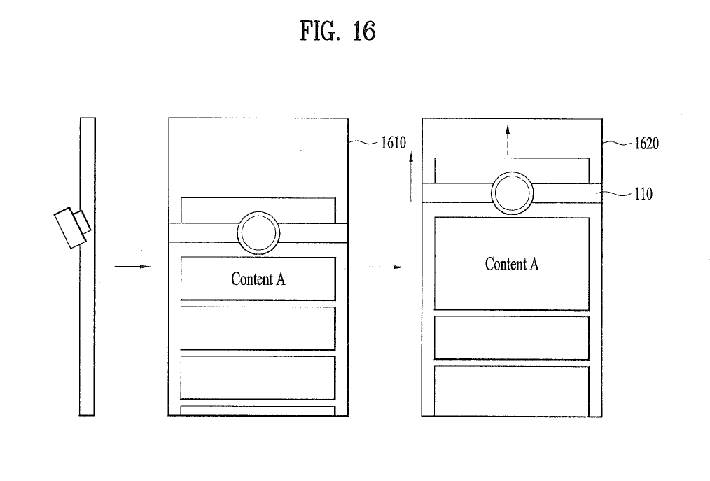

This will be described in detail with reference to FIG. 16 later.

The controller 120 differently controls a specific content corresponding to a location of the interface module 110 in accordance with a motion of a specific portion of the interface module 110.

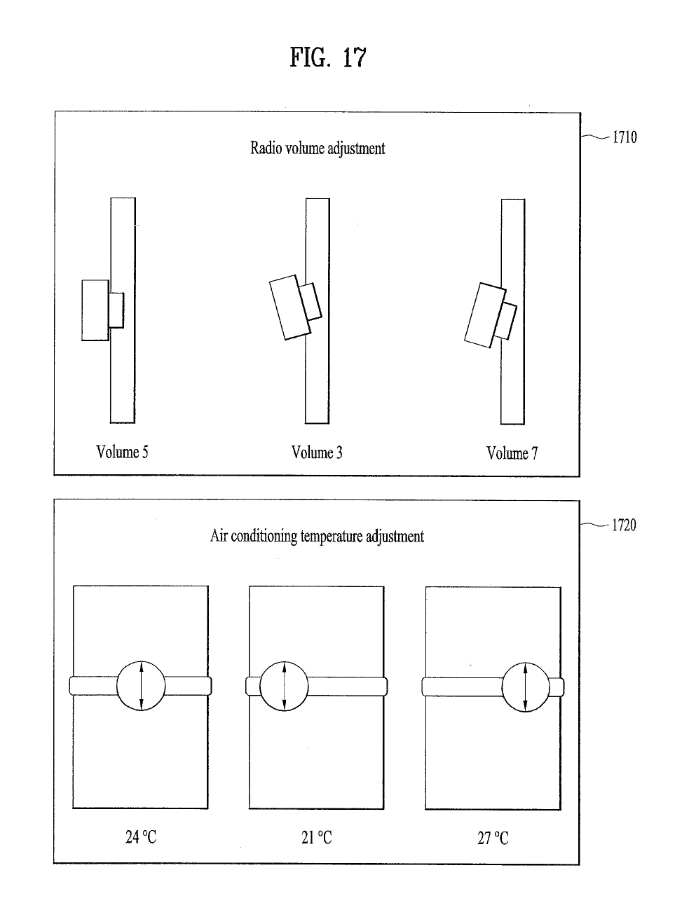

This will be described in detail with reference to FIG. 17 later.

The controller 120 differently changes a moving speed of the interface module 110 in accordance with a speed of the center fascia installed car.

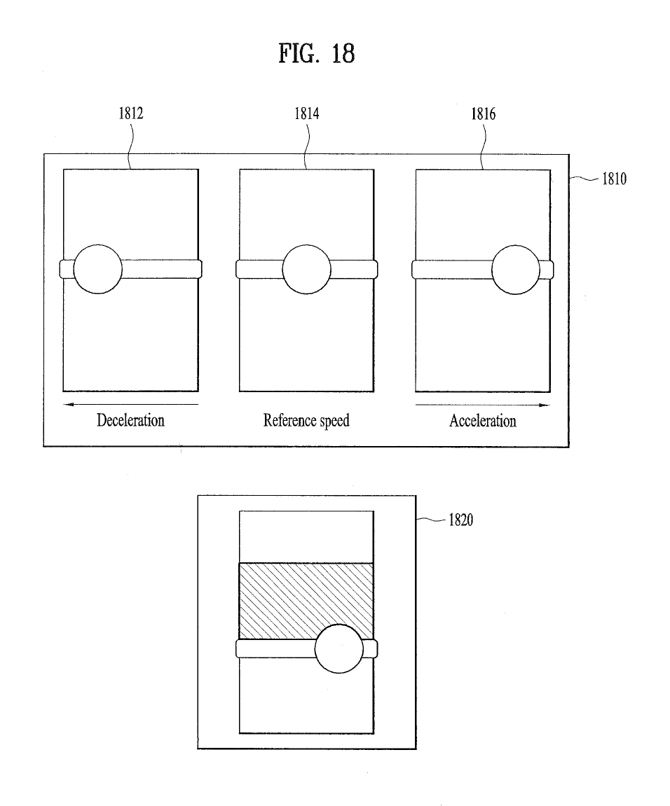

This will be described in detail with reference to FIG. 18 later.

The controller 120 determines a mode in accordance with a location of a specific portion of the interface module 110 and then displays a screen differently in accordance with the determined mode.

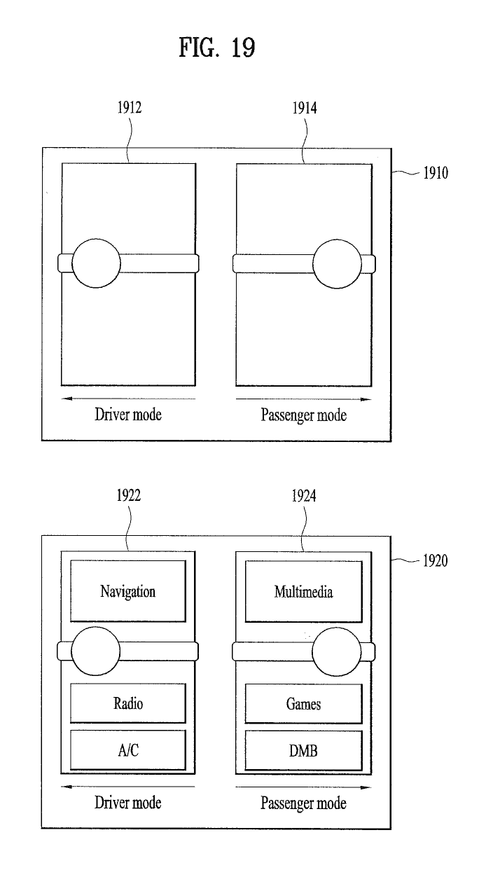

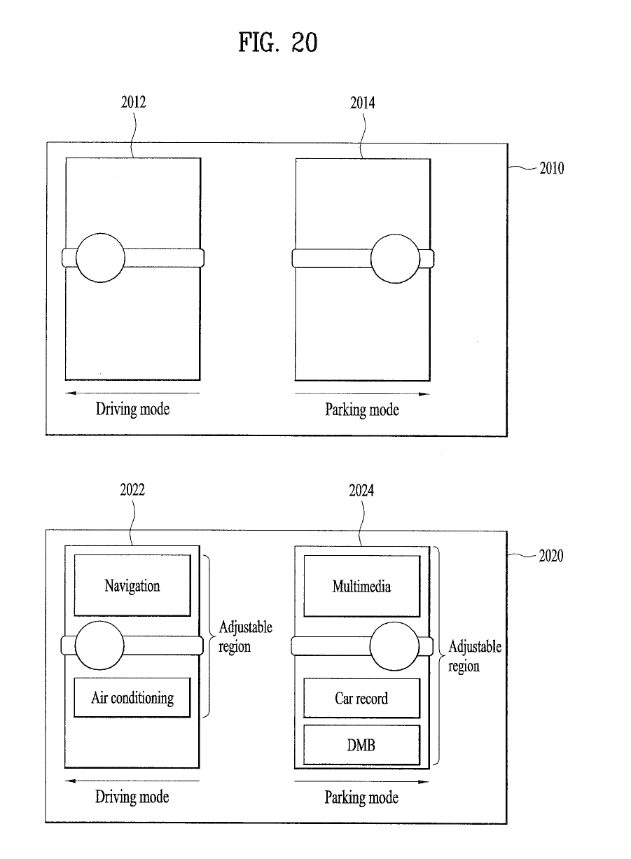

This will be described in detail with reference to FIG. 19 later.

The controller 120 determines a mode in accordance with a speed of the center fascia installed car and then displays a screen differently in accordance with the determined mode.

This will be described in detail with reference to FIG. 20 later.

When the interface module 110 is located at one of a top end or bottom end of a screen, if a user input for a specific portion of the interface module to face a specific direction in a current state is received from a user and an additional content failing to appear on the screen is present at an end portion of one of the top end and the bottom end of the screen, the controller displays the additional content on the screen.

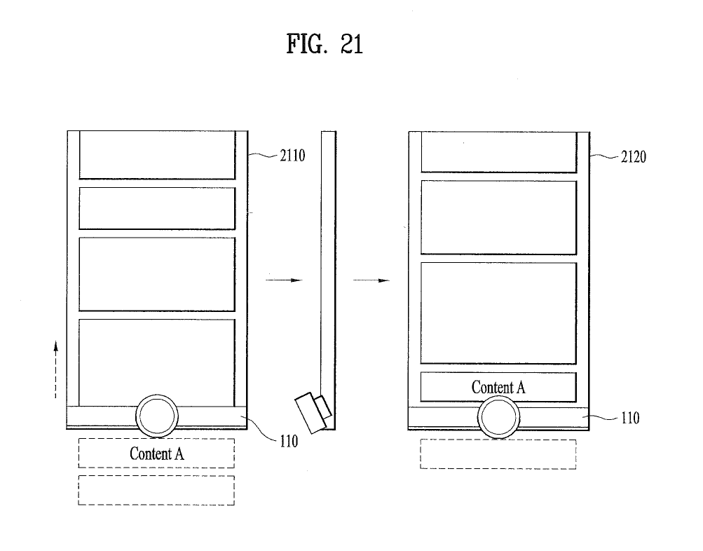

This will be described in detail with reference to FIG. 21 later.

The display module 130 displays a screen in accordance with a control command from the controller 120.

The sensor module 140 senses a location of a user.

The memory 150 stores the settings of the center fascia.

FIG. 2 is a flowchart of a center fascia controlling method according to one embodiment of the present invention. In particular, the present invention is implemented by the controller.

Referring to FIG. 2, first of all, a user input is received from a user through the interface module 110 [S210].

Secondly, a screen is displayed according to at least one of a location of the interface module 110, a direction faced by a specific portion of the interface module 110 and a touch input to the interface module 110 [S220].

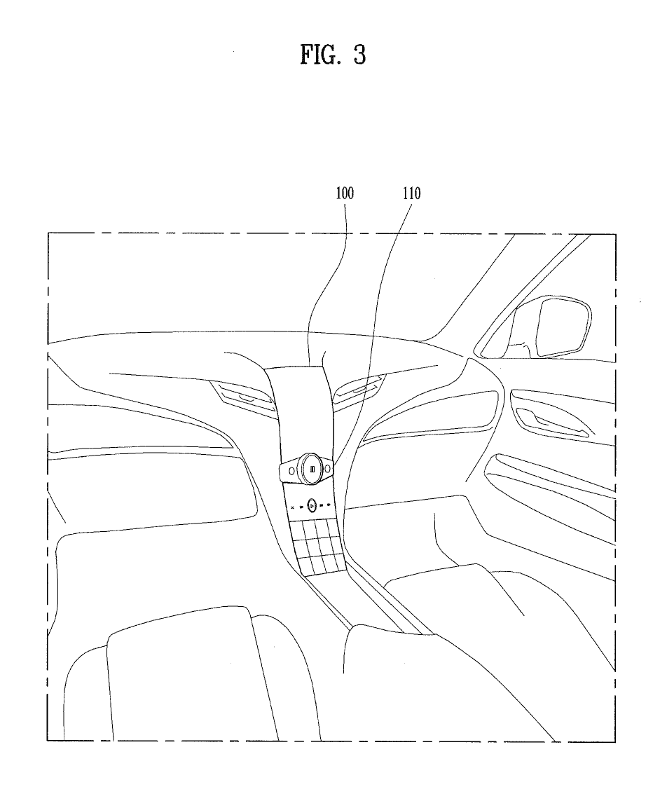

FIG. 3 is a diagram of a center fascia installed in a car according to one embodiment of the present invention.

Referring to FIG. 3, the center fascia 100 may be installed at a center of a dashboard of a car. And, the display module 130 displays a different screen in accordance with a location of the interface module 110.

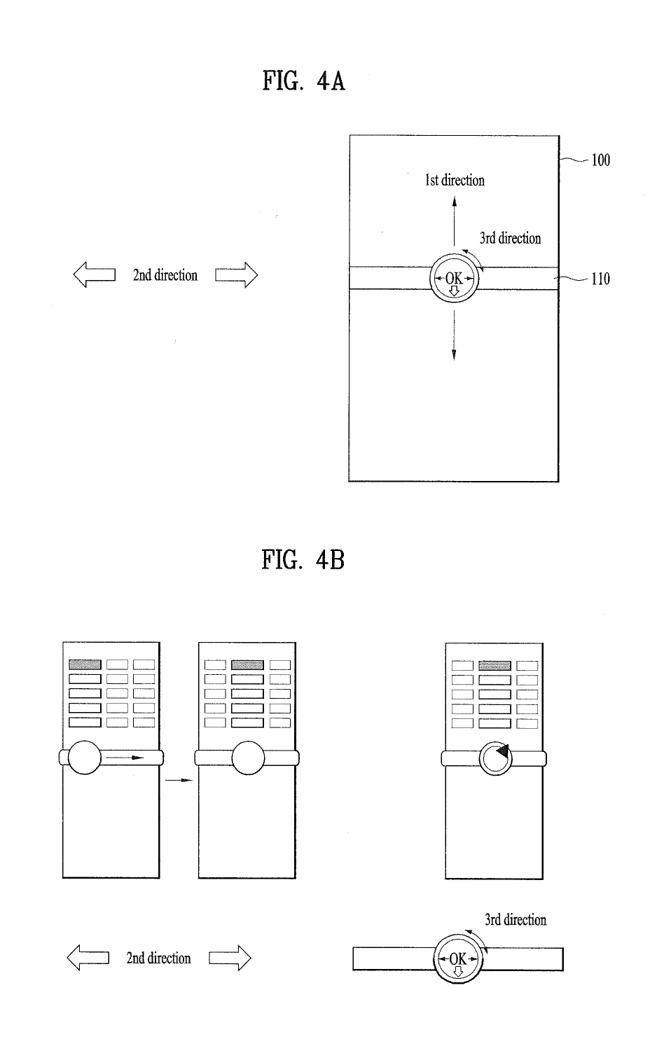

FIG. 4A and FIG. 4B are diagrams to describe basic operations of an interface module and such a specific portion of the interface module as a knob according to one embodiment of the present invention.

Referring to FIG. 4A, if a user input of moving the interface module 110 in a 1^{st} direction is received from a user, the controller 120 moves a category of a screen from a 1^{st} category to a 2^{nd} category different from the 1^{st} category. In this case, the 1^{st} direction may include a downward direction or an upward direction.

For instance, if an input of moving the interface module 110 in the downward direction is received from a user, the controller 120 moves the category of the screen to a radio from a navigation.

Referring to FIG. 4B, if a user input of moving a specific portion of the interface module 110 in a 2^{nd} direction is received from a user, the controller 120 moves a menu to a submenu of a current category. In this case, the 2^{nd} direction may include a right direction or a left direction. And, the specific portion may include a knob that is a handle of the interface module 110.

For instance, when an input of moving the knob corresponding to the specific portion of the interface module 110 in the right direction is received from a user, if a current category is a radio, the controller 120 moves gradually toward submenus in accordance with the movement of the knob as the input moves gradually in the right direction [e.g., FM channel→103.7 MHz].

For another instance, when an input of moving the knob corresponding to the specific portion of the interface module 110 in the left direction is received from a user, the controller 120 moves a current menu gradually toward supermenus in accordance with the movement of the knob [e.g., 103.7 MHz→FM channel→Radio].

If a user input of moving a specific portion of the interface module 110 in a 3^{rd} direction is received from a user, the controller 120 moves a menu from a 1^{st} menu to a 2^{nd} menu different from the 1^{st} menu. In this case, the 3^{rd} direction may mean a rotation direction of the knob. And, the 3^{rd} direction includes a case of rotating the knob in a left direction and a case of rotating the knob in a right direction.

For instance, if an input of rotating the knob in the left direction is received from a user, the controller 120 moves the menu from a current menu to a menu of one step above.

For another instance, if an input of rotating the knob in the right direction is received from a user, the controller 120 moves the menu from a current menu to a menu of one step below.

If an input of pushing the interface module 110 is received from a user, the controller 120 launches a specific function of a menu.

For instance, when the interface module 110 is located on a navigation screen, if an input of pushing the interface module 110 is received from a user, the controller 120 launches a navigation.

FIG. 5 is a diagram to describe an operation of adjusting an image displayed above an interface module in accordance with a property of a displayed content according to one embodiment of the present invention.

Referring to FIG. 5, the controller 120 adjusts an image displayed above the interface module 110 in accordance with a property of a displayed content.

Like an embodiment 510, if a content includes a map information and is a navigation, the controller 120 displays an image including top, bottom, right and left buttons on the interface module 110. If the image having the function of the top, bottom, right and left buttons is provided, a user can control the screen easily and conveniently.

Like an embodiment 510, if a content includes a grid type screen, the controller 120 displays an image meaning that a knob is rotatable on the interface module 110. If the image meaning that the knob is rotatable is provided, a user can control the screen easily and conveniently.

FIG. 6 is a diagram to describe an operation of activating a touch input function of an interface module in accordance with a property of a displayed content according to one embodiment of the present invention.

Referring to FIG. 6, the controller 120 activates a touch input function of the interface module 110 in accordance with a property of a displayed content.

Like an embodiment 610, if a content is a radio, the controller 120 deactivates a touch function of the interface module 110.

Like an embodiment 620, if a content is a navigation, the controller 120 activates a touch function of the interface module 110. Hence, a user can control a screen easily and conveniently using a touch function of a knob.

FIG. 7 is a diagram to describe an operation of displaying a screen by changing a size of a current screen region in case of moving in a 1^{st} direction while pushing an interface module according to one embodiment of the present invention.

Referring to FIG. 7, an embodiment 710 corresponds to a screen displayed by the center fascia 100. Contents may include a navigation, a media player, an air conditioning, and a phone.

If the interface module 110 is moved in a direction while pushed, the controller 120 displays a screen region by changing a size of a current screen region.

Like an embodiment 720, if the interface module 110 is moved in a downward direction, the controller 120 moves a current content to the media player from the navigation.

Like an embodiment 730, if the interface module 110 is moved in a downward direction while pushed, the controller 120 displays a screen by enlarging a navigation screen that is a current screen. In this case, the screen enlargement can be performed as much as a downward movement of the interface module 110.

FIG. 8 is a diagram to describe an operation of generating a haptic feedback, if an interface module is located in a prescribed distance from a specific location of a specific indicator, according to one embodiment of the present invention.

Referring to FIG. 8, if the interface module 110 is situated within a prescribed distance from a specific location at which a specific indicator is located, the controller 120 generates a haptic feedback.

Like an embodiment 810, the interface module 110 is situated at a point at which a 1^{st} content ends.

Like an embodiment 820, if the interface module 110 is moved from a 1^{st} content end point to a 2^{nd} content end point by sliding, the controller 120 generates a haptic feedback at the 2^{nd} content end point. In this case, the haptic feedback is to generate vibration from a specific point. The controller 120 generates the vibration from the 2^{nd} content end point, thereby providing a user with a sense of a clicking latch.

FIG. 9 is a diagram to describe an operation of generating a haptic feedback, if an interface module is located in a prescribed distance from a specific location of a specific indicator, according to one embodiment of the present invention.

Referring to FIG. 9, if the interface module 110 is situated within a prescribed distance from a specific location at which a specific indicator is located, the controller 120 generates a haptic feedback.

The interface module 110 further includes a recognition sensor (not shown in the drawing) configured to recognize a specific indicator.

Like an embodiment 910, when the interface module 110 is moved from a 1^{st} point, at which a 1^{st} indicator is located, to a 2^{nd} point at which a 1^{st} indicator is located, the controller 120 recognizes a current location using the recognition sensor and then calculates a distance to the 2^{nd} indicator. If the interface module 110 is situated within a distance of 0.5 cm from the 2^{nd} indicator, the controller 120 generates a haptic feedback.

FIG. 10 is a diagram to describe an operation of differently changing a shape of a knob in accordance with a speed of a center fascia installed car according to one embodiment of the present invention.

Referring to FIG. 10, the controller 120 changes a shape of the interface module 110 differently in accordance with a speed of a center fascia installed car.

Like an embodiment 1010, if a sped of a car is slower than a reference value, the controller 120 sets a shape of the interface module 110 to a thin knob to be optimized for a screen design. In this case, the reference value may become 40 km/h and are adjustable into various values.

Like an embodiment 1020, if a speed of the car is faster than the reference value, the controller 120 sets the shape of the interface module 110 to a projected shape.

According to the present invention, in case that the vehicle speed is slow, the shape of the knob is set to the thin knob optimized for the screen design. If the vehicle speed is fast, the shape of the knob is set to the projected shape to facilitate manipulation. Therefore, user convenience can be enhanced.

FIG. 11 is a diagram to describe an operation of differently changing a location of an interface module and a screen corresponding to the interface module in accordance with a speed of a center fascia installed car according to one embodiment of the present invention.

Referring to FIG. 11, the controller 120 differentiates a location of the interface module 110 and a screen corresponding to the interface module 110 in accordance with a center fascia installed car.

Like an embodiment 1110, in case that a speed of a car is faster than a reference value, since it is highly possible that a driver may need a navigation, the controller 120 moves the interface module 110 to an end portion of the navigation, sets a screen corresponding to the interface module 110 as the navigation, and sets a navigation screen size to a value greater than a normal size. In this case, the reference value may become 40 km/h or 0 km/h and is adjustable into various values.

Like an embodiment 1120, in case that the speed of the car is slower than the reference value, since it is highly possible that the driver may need an air conditioning screen, the controller 120 moves the interface module 110 to an end portion of an air conditioning, sets a screen corresponding to the interface module 110 as the air conditioning, sets an air conditioning screen size to a size smaller than a normal value, and displays such contents related to the air conditioning as a temperature setting, a wind strength, a wind mode and the like. In this case, the reference value may become 40 km/h or 0 km/h and is adjustable into various values.

According to the present invention, in case that the vehicle speed is slow, a large number of informations are displayed on the screen. In case that the vehicle speed is fast, a small number of informations necessary to drive the car are displayed on the screen. Hence, user convenience can be enhanced.

FIG. 12 is a diagram to describe an operation of automatically returning an interface module to an original location in case of starting an engine of a car according to one embodiment of the present invention.

Referring to FIG. 12, if an engine start of a center fascia installed car is activated, the controller 120 moves the interface-module 110 to a preset specific location.

Like an embodiment 1210, before starting an engine of a car, the interface module 110 is situated at a prescribed specific location.

Like an embodiment 1220, after the engine start of the car has been activated, the controller 120 moves the interface module 110 to a specific location. In this case, the specific location may include one of an initially set location, a location at which a user used a specific content last, a location at which a navigation mode is usable, a location at which a user welcome function can be launched, and the like.

FIG. 13 is a diagram to describe an operation of differentiating a moving speed in case of moving an interface module up/down in accordance with a direction of a knob according to one embodiment of the present invention.

Referring to FIG. 13, like an embodiment 1310, a direction faced by a knob includes one of a normal case 1312, a case 1314 that the knob faces a downward direction, and a case 1316 that the knob faces an upward direction.

The controller 120 differentiates a moving speed of the interface module 110 in accordance with a direction faced by a specific portion of the interface module 110 and a moving direction of the interface module 110.

If the direction faced by the specific portion of the interface module 110 is equal to the moving direction of the interface module 110, the controller 120 directly moves the interface module 110 in a Pt direction without holding.

Like an embodiment 1320, if the direction faced by the knob and the moving direction of the interface module 110 are downward, the controller 120 directly moves the interface module 110 in the downward direction. In doing so, the controller 120 does not stop the interface module 110 at a specific point in-between.

Like an embodiment 1330, if the direction faced by the knob and the moving direction of the interface module 110 are upward, the controller 120 directly moves the interface module 110 in the upward direction. In doing so, the controller 120 does not stop the interface module 110 at a specific point in-between.

According to the present invention, if the direction faced by the knob is equal to the moving direction of the interface module 110, the interface module 110 can be moved to a location desired by a user without a held section in-between. Hence, user convenience can be enhanced.

FIG. 14 is a diagram to describe an operation of differentiating a moving speed in case of moving an interface module up/down in accordance with a direction of a knob according to one embodiment of the present invention.

Referring to FIG. 14, if a direction faced by a specific portion of the interface module 110 is opposite to a moving direction of the interface module 110, the controller 120 moves the interface module 110 in a Pt direction at a speed slower than a reference value. In this case, the reference value may become 10 m/s and is adjustable by user settings.

Like an embodiment 1410, if a direction faced by the knob is a downward direction and a moving direction of the interface module 110 is an upward direction, the controller 120 moves the interface module 110 in the upward direction at a speed slower than a reference value.

Like an embodiment 1420, if a direction faced by the knob is the upward direction and a moving direction of the interface module 110 is the downward direction, the controller 120 moves the interface module 110 in the downward direction at a speed slower than the reference value.

According to the present invention, if a direction faced by the knob and a moving direction of the interface module 110 are opposite to each other, the interface module 110 is made to move at a speed slower than a reference value. Hence, when the interface module 110 moves, a user can be informed of a malfunction or a location of the interface module 110 can be set precisely. Thus, user's convenience can be enhanced.

FIG. 15 is a diagram to describe a case of changing a content by tilting a knob up/down according to one embodiment of the present invention.

Referring to FIG. 15, if an input for a specific portion of the interface module 110 to face an upward direction in a current state is received from a user, the controller 120 controls a content below the interface module 110 to be displayed above the interface module 110 with reference to the interface module 110.

Like an embodiment 1510, if an input for the knob to face the upward direction in a current state without moving the knob is received from a user, the controller 120 displays

Content B below the interface module 110 on the interface module 110 with reference to the interface module 110 and also displays Content C and Content D by raising contents below the interface module 110 by one level each.

Moreover, if an input for a specific portion of the interface module 110 to face a downward direction in a current state is received from a user, the controller 120 controls a content above the interface module 110 to be displayed below the interface module 110 with reference to the interface module 110.

Like an embodiment 1520, if an input for the knob to face the downward direction in a current state without moving the knob is received from a user, the controller 120 controls Content B above the interface module 110 to be displayed below the interface module 110 with reference to the interface module 110, controls Content C to be displayed by lowering contents below the interface module 110 by one level each, and also controls Content A to be displayed above Content A.

FIG. 16 is a diagram to describe a case that a content size is different in case of changing a content by tilting a knob up/down according to one embodiment of the present invention.

Referring to FIG. 16, after an input for a specific portion of the interface module 110 to face a specific direction in a current state has been received from a user, if the input is released, the controller 120 adjusts a size of a screen region corresponding to a specific content and then displays a size adjusted screen corresponding to the specific content.

Like an embodiment 1610, an input for the knob to face a downward direction is a current state is received from a user.

Like an embodiment 1620, after the input has been released in a manner that the user releases a hand or finger from the knob, the controller 120 adjusts a size of a screen region corresponding to Content A and then displays a size adjusted screen region corresponding to Content A.

According to the present invention, when a content is switched by tiling the knob up/down, if a content size is different, since a current location of the knob is not changed at a top or bottom end of the content, a user can switch a content at a current location irrespective of a size of the corresponding content. Moreover, as the user completes a content selection, if the user releases a hand from the knob, a location of the knob is automatically corrected so that a screen for displaying the content can be automatically switched to a full screen without being cut. Hence, user convenience can be enhanced.

FIG. 17 is a diagram to describe a case of controlling a specific content corresponding to a location of an interface module in accordance with a movement of a specific portion of the interface module according to one embodiment of the present invention.

Referring to FIG. 17, the controller controls a specific content corresponding to a location of the interface module 110 differently in accordance with a movement of a specific portion of the interface module 110.

Like an embodiment 1710, when a content corresponding to a location of the interface module 110 is a radio, if an input for the knob to face a downward direction is received from a user, the controller 120 adjusts a radio volume from 5 to 3. Moreover, if an input for the knob to face an upward direction is received from a user, the controller 120 adjusts a radio volume from 5 to 7.

Like an embodiment 1720, when a content corresponding to a location of the interface module 110 is an air conditioner, if an input for the knob to face a right side is received from a user, the controller 120 adjusts an air conditioning temperate from 24° C. to 27° C. Moreover, if an input for the knob to face a left side is received from a user, the controller 120 adjusts the air conditioning temperature volume from 24° C. to 21° C.

According to the present invention, since an increase/decrease value of a content can be precisely controlled in a manner of combining a movement of the knob with the content situated below the interface module 110, user convenience can be enhanced.

FIG. 18 is a diagram to describe an operation of controlling a sliding speed of a knob in accordance with a car speed according to one embodiment of the present invention.

Referring to FIG. 18, the controller 120 differently changes a moving speed of the interface module 110 in accordance with a speed of a center fascia installed car.

Like an embodiment 1810, a location of the knob is changed in accordance with a car speed. If the car speed is smaller than a reference speed [1812], the knob is situated at a left side. If the car speed is equal to the reference speed [1814], the knob is situated at a center. If the car speed is greater than the reference speed [1816], the knob is situated at a right side. In this case, the reference speed may include 40 km/h and is changeable in accordance with a user setting.

If the location of the knob is situated at the left side, the controller 120 controls a moving speed of the interface module 110 to be changed into a value faster than the reference value.

If the location of the knob is situated at the right side, the controller 120 controls a moving speed of the interface module 110 to be changed into a value slower than the reference value.

Like an embodiment 1820, if the car speed is greater than the reference speed [1814], the knob is situated at the right side. In this case, the controller 120 can control a size of a movable region of the interface module 110 to become smaller than that of a normal region.

According to the present invention, if a car speed is faster than a reference speed, the controller 120 controls a moving speed of the interface module 110 to be changed into a slow speed and limits a movable region of the interface module 110. Hence, a danger of a safety accident can be prevented.

FIG. 19 is a diagram to describe an operation of arranging contents differently in accordance with a mode according to one embodiment of the present invention.

Referring to FIG. 19, the controller 120 determines a mode in accordance with a location of a specific portion of the interface module 110 and then displays a screen differently in accordance with the determined mode.

Like an embodiment 1910, mode types may include a driver mode 1912 and a passenger mode 1914. The driver mode 1912 corresponds to a case that the knob is situated at a left side and includes the mode of arranging contents appropriate for a driver. The passenger mode 1914 corresponds to a case that the knob is situated at a right side and includes the mode of arranging contents appropriate for a passenger.

Like an embodiment 1920, if the knob is situated at the left side, the controller 120 determines a mode as the driver mode 1922 and displays a content (e.g., navigation, radio, air conditioning, etc.) on a screen based on the driver mode 1922.

Moreover, if the knob is situated at the right side, the controller 120 determines a mode as the passenger mode 1924 and displays a content (e.g., multimedia player, games, DMB, etc.) on a screen based on the passenger mode 1924.

FIG. 20 is a diagram to describe an operation of arranging contents differently in accordance with a car speed and a mode according to one embodiment of the present invention.

Referring to FIG. 20, the controller 120 determines a mode in accordance with a speed of a center fascia installed car and then displays a screen differently in accordance with the determined mode.

Like an embodiment 2010, mode types may include a driving mode 2012 and a parking mode 2014. The driving mode 2012 corresponds to a case that a speed of a car is equal to or greater than a prescribed speed and includes the mode of arranging contents appropriate for a driving state. The passenger mode 2014 corresponds to a case that a speed of the car is 0 and includes the mode of arranging contents appropriate for a stop state.

If a speed of the car is equal to or greater than a prescribed speed, the controller 120 determines a current mode as the driving mode 2012 and then disposes the knob at a left side. If a speed of the car is 0, the controller 120 determines a current mode as the parking mode 2014 and then disposes the knob at a right side.

Like an embodiment 2020, if the knob is situated at the left side, the controller 120 displays contents (e.g., navigation, air conditioning, etc.) on a screen based on the driving mode 2012.

If the knob is situated at the right side, the controller 120 determines a current mode as the parking mode 2024 and then displays contents (e.g., multimedia, car record, DMB, etc.) on a screen based on the parking mode 2024.

In case of the driving mode, the controller 120 controls an adjustable region for content disposition to become smaller than a reference region of a display region. In case of the parking mode, the controller 120 controls the adjustable region for content disposition to become a full region of the display region.

According to the present invention, in case of the driving mode, a size of an adjustable region for content disposition can be decreased to prevent driver's distraction. Hence, safety accidents can be prevented.

FIG. 21 is a diagram to describe an operation of when a knob is situated at the end of a display region, if an additional content exists in case of tilting the knob in an edge direction, displaying the additional content on a screen according to one embodiment of the present invention.

Referring to FIG. 21, when the interface module 110 is situated one of a top end or bottom end of a screen, if an input for a specific portion of the interface module 110 to face a specific direction in a current state is received from a user and an additional content failing to appear on the screen is present at an edge of one of the top and bottom ends of the screen, the controller 120 displays the additional content on the screen.

Like an embodiment 2110, the interface module 110 is situated at the bottom end of the screen and Content A is present at the bottom end of the screen in a current state.

Like an embodiment 2120, if an input for the knob to face a downward direction is received from a user, the controller 120 displays Content A on the screen.

According to the present invention, although a user moves the interface module 110 to a most bottom or top end, if an unseen content still exists, the corresponding content is made to appear on a screen automatically. In particular, when an unseen additional content is present at a top or bottom end of the screen, if a user tilts the knob to face a specific direction, the additional content is displayed on the screen. Hence, user convenience can be enhanced.

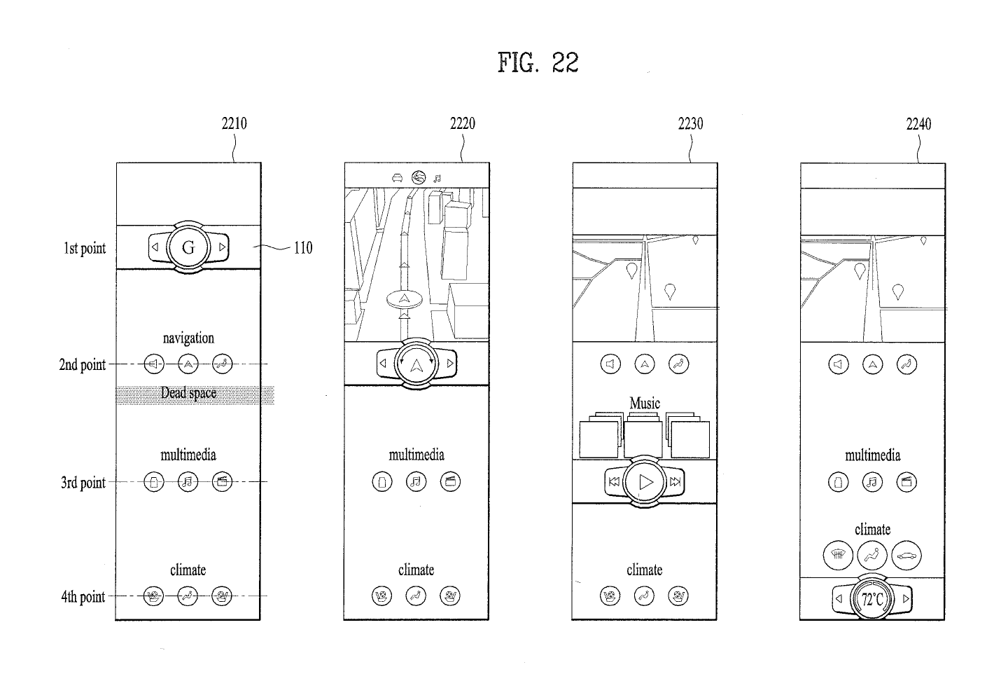

FIG. 22 is a diagram to describe an operation for a display module to display a different screen in accordance with a location of an interface module according to one embodiment of the present invention.

Referring to FIG. 22, like an embodiment 2210, if the interface module 110 is situated at a 1^{st} point, the controller 120 deactivates a full screen.

Like an embodiment 2220, if the interface module 110 is situated at a 2^{nd} point, the controller 120 displays a navigation on a screen and adjusts an image above the interface module 110 to fir the navigation.

Like an embodiment 2230, if the interface module 110 is situated at a 3^{rd} point, the controller 120 displays a multimedia on the screen and adjusts an image above the interface module 110 to fit the multimedia. In this case, if a content corresponding to the location of the interface module 110 is the multimedia, the controller 120 controls the navigation, of which minimal functions are activated only, to be displayed on the screen.

Like an embodiment 2240, if the interface module 110 is situated at a 4^{th} point, the controller 120 displays an air conditioning image on the screen and adjusts an image above the interface module 110 to fit the air conditioning. In this case, if a content corresponding to the location of the interface module 110 is an air conditioning, the controller controls the navigation, of which minimal functions are activated only, to be displayed on the screen and deactivates the multimedia screen.

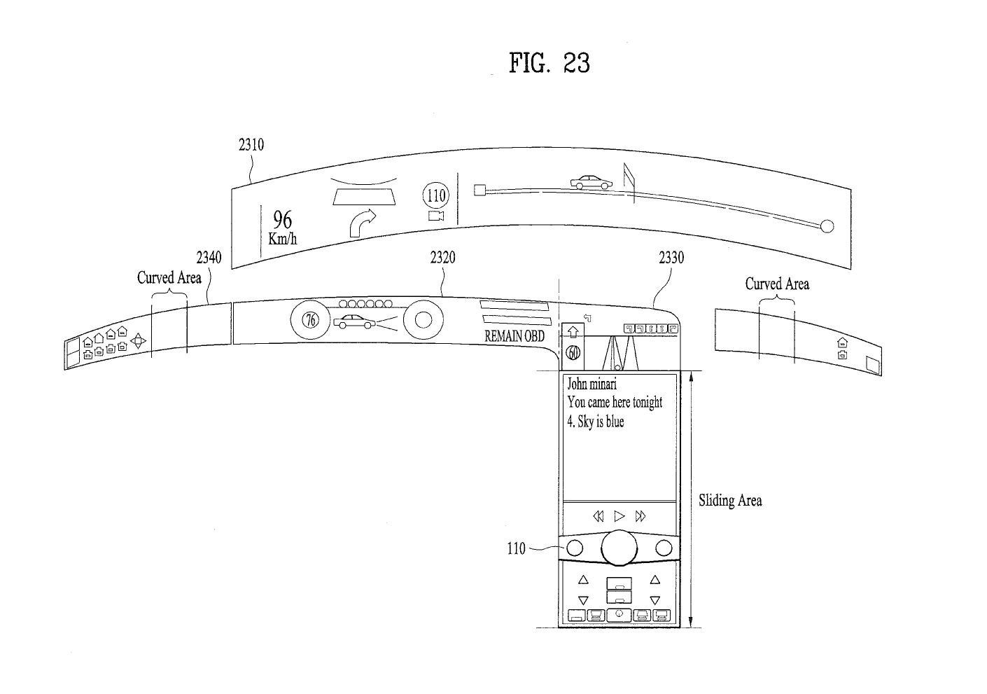

FIG. 23 is a diagram if screens displayed by a head-up display, a cluster, a center fascia, a driver seat window, and a passenger seat window according to one embodiment of the present invention.

Referring to FIG. 23, like an embodiment 2310, a head-up display displays a current speed of a car, an image of intending to make a right turn after a while, a location of a speed camera, a distance between origin and destination, a time, a current location of the car and the like.

Like an embodiment 2320, a cluster displays a current speed of the car, a gear step (e.g., 1^{st}, 2^{nd}, etc.), a headlight ON/OFF, a car RPM and the like.

Like an embodiment 2330, a center fascia displays a navigation screen, a multimedia screen, an air conditioning screen and the like. In this case, a location of the interface module 110 can be adjusted upward or downward.

Like an embodiment 2340, a driver seat window displays a window adjustment, a door lock, a side mirror control screen, and the like.

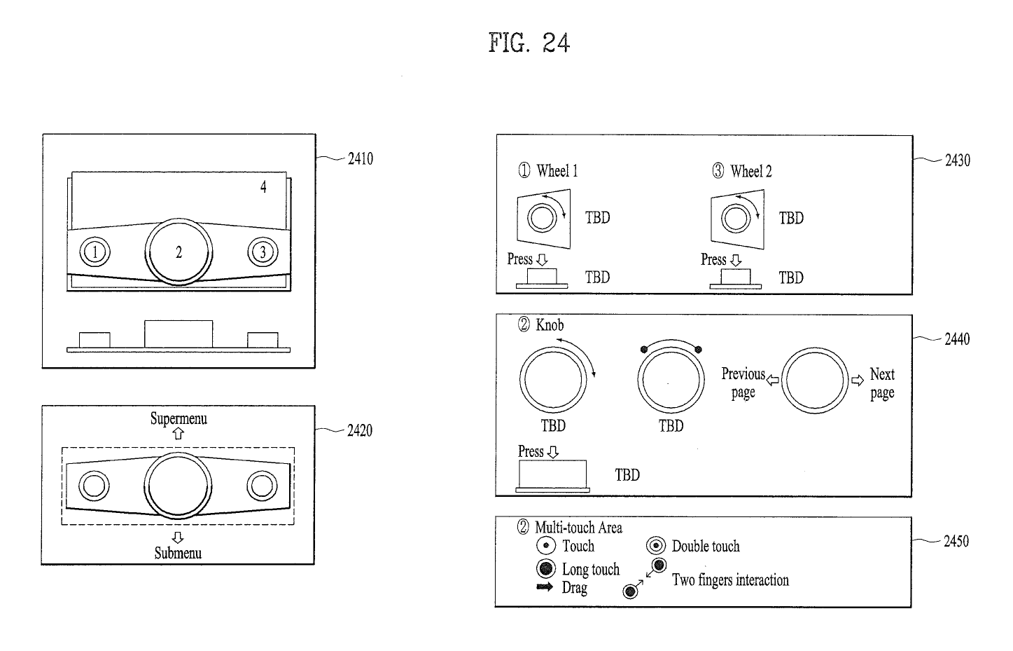

FIG. 24 is a diagram to describe operating functions of an interface module and a specific portion of a knob of the interface module according to one embodiment of the present invention.

Referring to FIG. 24, like an embodiment 2410, the interface module 110 includes specific portions such as three knobs and the like.

Like an embodiment 2420, if an input of pushing a top portion of a center knob is received from a user, the controller 120 displays a super menu. If an input of pressing a bottom portion of the center knob is received from a user, the controller 120 displays a submenu.

Like an embodiment 2430, a wheel is rotatable in both directions and may be able to receive a touch input of pressing a top of the wheel.

Like an embodiment 2440, the knob is rotatable in both directions and may be able to receive a touch input of pressing a top of the knob from a user.

Like an embodiment 2450, a multi-touch region can receive various touch inputs from a user.

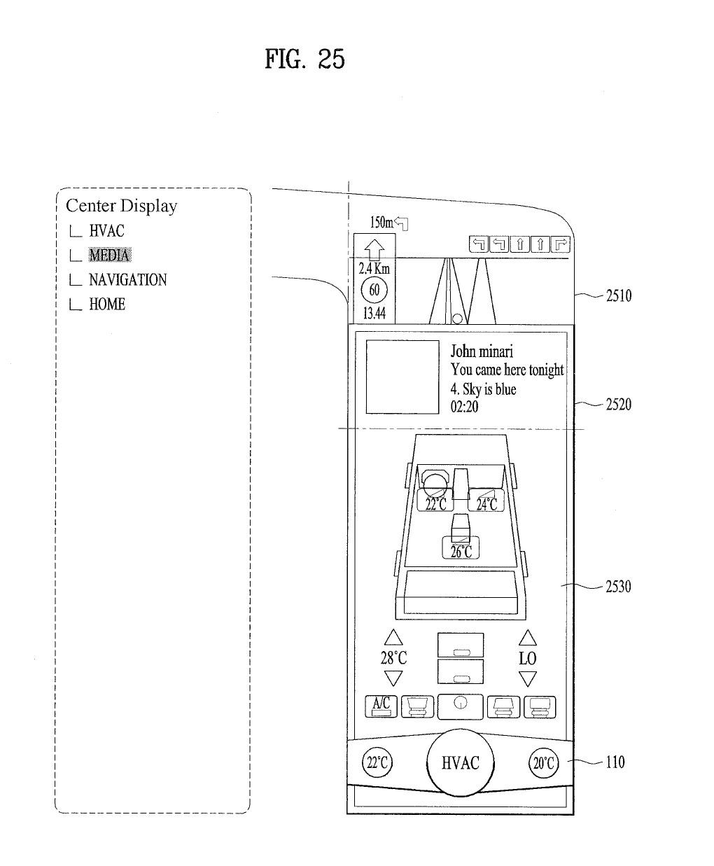

FIG. 25 is a diagram to describe an operation for a display module to display a different screen in accordance with a location of an interface module according to one embodiment of the present invention.

Referring to FIG. 25, a current location of the interface module 110 is situated at an air conditioning. Hence, a size of a screen for displaying an air conditioning information is the largest.

According to an embodiment 2510, the controller 120 displays a navigation information on a screen.

According to an embodiment 2520, the controller 120 displays a currently played media information on the screen.

According to an embodiment 2530, the controller 120 displays an air conditioning information of a car on the screen.

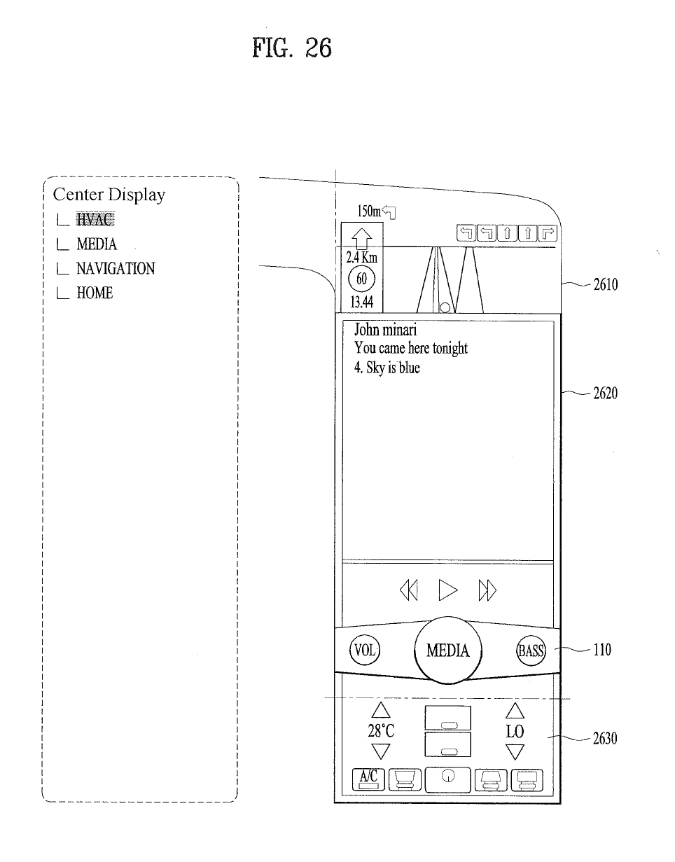

FIG. 26 is a diagram to describe an operation for a display module to display a different screen in accordance with a location of an interface module according to one embodiment of the present invention.

Referring to FIG. 26, a current location of the interface module 110 is situated at media. Hence, a size of a screen for displaying a media information is the largest.

According to an embodiment 2610, the controller 120 displays a navigation information on a screen.

According to an embodiment 2620, the controller 120 displays a currently played media information on the screen.

According to an embodiment 2630, the controller 120 displays an air conditioning information of a car on the screen.

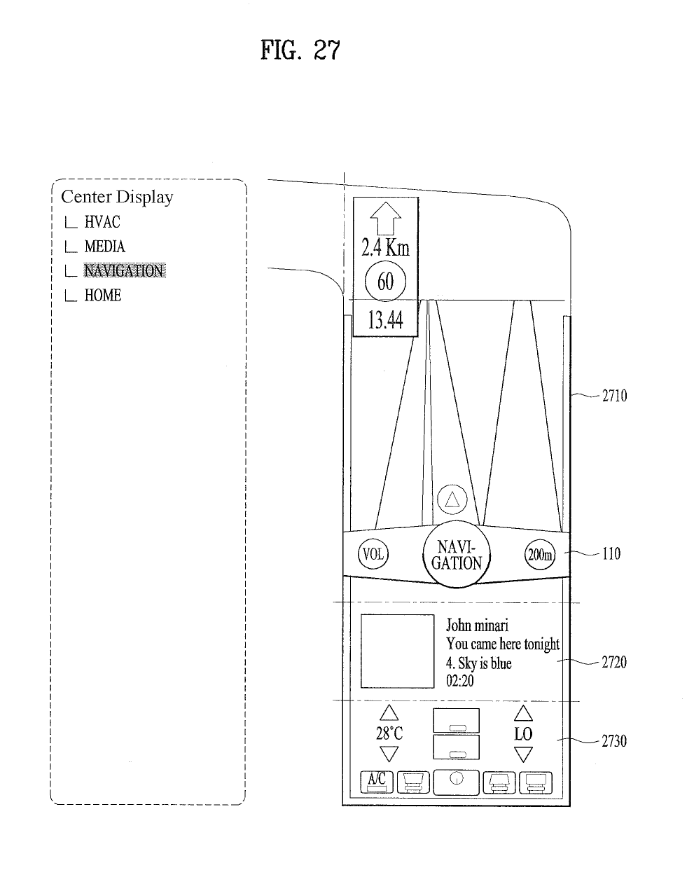

FIG. 27 is a diagram to describe an operation for a display module to display a different screen in accordance with a location of an interface module according to one embodiment of the present invention.

Referring to FIG. 27, a current location of the interface module 110 is situated at a navigation. Hence, a size of a screen for displaying a navigation information is the largest.

According to an embodiment 2710, the controller 120 displays a navigation information on a screen.

According to an embodiment 2720, the controller 120 displays a currently played media information on the screen.

According to an embodiment 2730, the controller 120 displays an air conditioning information of a car on the screen.

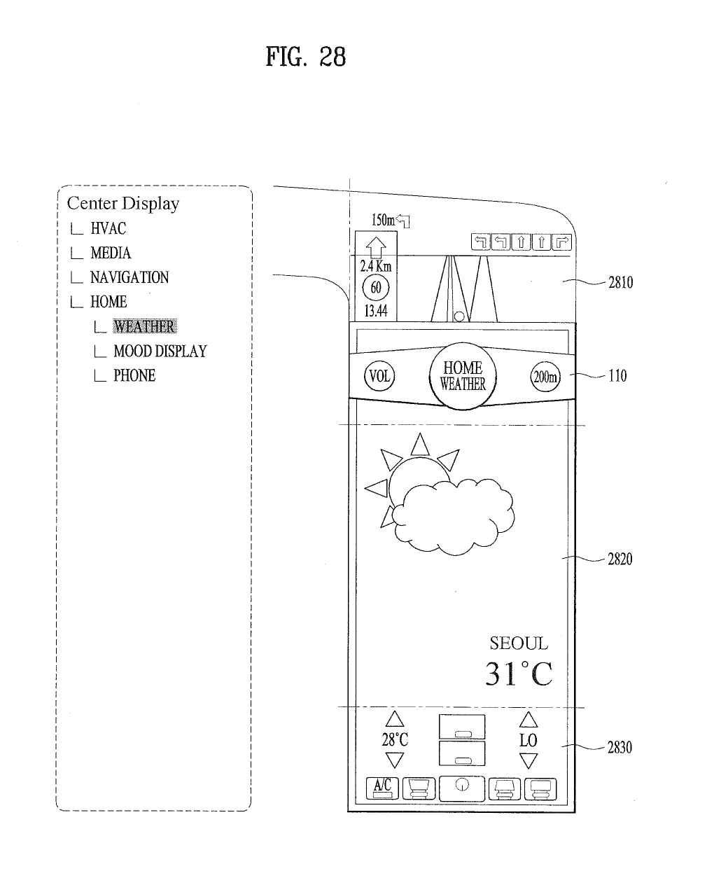

FIG. 28 is a diagram to describe an operation for a display module to display a different screen in accordance with a location of an interface module according to one embodiment of the present invention.

Referring to FIG. 28, a current location of the interface module 110 is situated at Home. Hence, a size of a screen for displaying a weather information conceptionally subordinate to Home is the largest.

According to an embodiment 2810, the controller 120 displays a navigation information on a screen.

According to an embodiment 2820, the controller 120 displays a current weather information on the screen.

According to an embodiment 2830, the controller 120 displays an air conditioning information of a car on the screen.

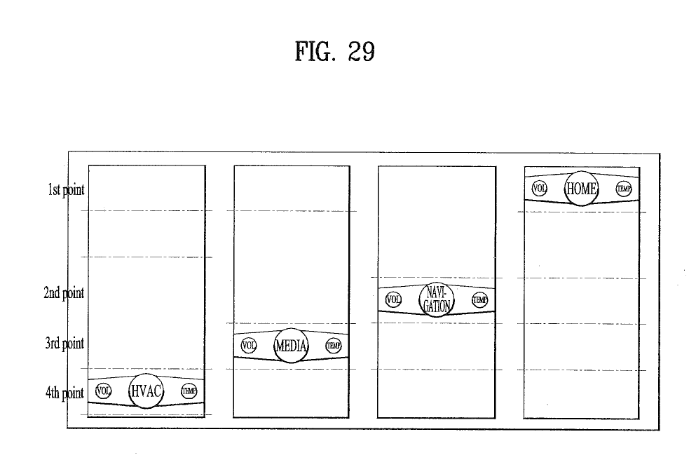

FIG. 29 is a diagram to describe a function activated in accordance with a location of an interface module according to one embodiment of the present invention.

Referring to FIG. 29, like an embodiment 2910, the controller 120 controls the interface module 110 to stop at a 1^{st} point, a 2^{nd} point, a 3^{rd} point or a 4^{th} point only. If an input of moving the interface module 110 from a specific point in an upward or downward direction is received from a user, the controller 120 moves the interface module 110 to a closest point among the 4 points.

According to one embodiment of the present invention, a content corresponding to a location in accordance with a location of an interface module and a control direction of a knob is displayed on a screen and a specific function of a content corresponding to the interface module is then launched, whereby a display screen optimized for a user can be embodied. Hence, user convenience can be enhanced.

According to another embodiment of the present invention, an image displayed above an interface module is adjusted in accordance with a property of a displayed content and a touch input function of the interface module can be activated, thereby enhancing user's convenience.

According to further embodiment of the present invention, a shape of an interface module, a location of the interface module and a screen corresponding to the interface module are displayed differently in accordance with a speed of a center fascia installed car, thereby enhancing user's convenience.

According to another further embodiment of the present invention, a moving speed of an interface module is differentiated in accordance with a direction faced by a specific portion of an interface module and a moving direction of the interface module, thereby enhancing user's convenience.

While the present invention has been described and illustrated herein with reference to the preferred embodiments thereof, it will be apparent to those skilled in the art that various modifications and variations can be made therein without departing from the spirit and scope of the invention. Therefore, the embodiments disclosed in the present invention are provided not to limit but to describe the technical idea of the present invention. And, the scope of the appended claims and their equivalents is non-limited by those embodiments. Thus, it is intended that the present invention covers the modifications and variations of this invention that come within the scope of the appended claims and their equivalents.

### MODE FOR INVENTION

Various embodiments are described in BEST MODE FOR INVENTION.

### INDUSTRIAL APPLICABILITY

The present invention is used for a series of center fascia fields.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A center fascia, comprising:
an interface module configured to receive a user input from a user;
a controller configured to differently display a screen in accordance with at least one selected from the group consisting of a location of the interface module, a direction faced by a specific portion of the interface module and a touch input to the interface module; and
a display module configured to display the screen in accordance with a control command from the controller,
wherein the controller is further configured to:
move a category of the screen from a first category to a second category different from the first category if receiving an input of moving the interface module in a first direction from the user,
move a menu of the category to either a submenu or a supermenu if receiving a user input of moving the specific portion of the interface module in a second direction from the user,
move the menu from a first menu to a second menu different from the first menu if receiving a user input of moving the specific portion of the interface module in a third direction from the user, and
launch a specific function of the menu if receiving an input of pushing the interface module from the user.

2. The center fascia of claim 1, wherein the controller is further configured to adjust an image displayed above the interface module in accordance with a property of a displayed content.

3. The center fascia of claim 1, wherein the controller is further configured to activate a touch input function of the interface module in accordance with a property of a displayed content.

4. The center fascia of claim 1, wherein the controller is further configured to change a size of a current screen region and then display a size changed screen region if the interface module is moved in the first direction while pushed.

5. The center fascia of claim 1, wherein the controller is further configured to generate a haptic feedback if the interface module is situated within a prescribed distance from a specific location having a specific indicator located thereat.

6. The center fascia of claim 1, wherein the controller is further configured to change a shape of the interface module differently in accordance with a speed of a car having the center fascia installed thereon.

7. The center fascia of claim 1, wherein the controller is further configured to change a location of the interface module and a screen corresponding to the interface module differently in accordance with a speed of a car having the center fascia installed therein.

8. The center fascia of claim 1, wherein the controller is further configured to move the interface module to a preset specific location if an engine of a car having the center fascia installed therein is started.

9. The center fascia of claim 1, wherein the controller is further configured to differentiate a moving speed of the interface module in accordance with the direction faced by the specific portion of the interface module and a moving direction of the interface module.

10. The center fascia of claim 9, wherein the controller is further configured to directly move the interface module in the first direction without holding if the direction faced by the specific portion of the interface module and the moving direction of the interface module are identical to each other.

11. The center fascia of claim 9, wherein the controller is further configured to move the interface module in the first direction at a speed slower than a reference value if the direction faced by the specific portion of the interface module and the moving direction of the interface module are opposite to each other.

12. The center fascia of claim 1, wherein the controller is further configured to control a content above the interface module to be displayed below the interface module with reference to the interface module if receiving an input for the specific portion of the interface module to face a downward direction from the user in a current state.

13. The center fascia of claim 1, wherein the controller is further configured to control a content below the interface module to be displayed above the interface module with reference to the interface module if receiving an input for the specific portion of the interface module to face an upward direction from the user in a current state.

14. The center fascia of claim 1, wherein the controller is further configured to, after an input for the specific portion of the interface module to face a specific has been received from the user in a current state:
adjust a size of a screen region corresponding to a specific content and then display the size adjusted screen region corresponding to the specific content if the input is released.

15. The center fascia of claim 1, wherein the controller is further configured to control a specific content corresponding to the location of the interface module differently in accordance with a movement of the specific portion of the interface module.

16. The center fascia of claim 1, wherein the controller is further configured to change a moving speed of the interface module differently in accordance with a speed of a car having the center fascia installed therein.

17. The center fascia of claim 1, wherein the controller is further configured to determine a mode in accordance with a location of the specific portion of the interface module and then display the screen differently in accordance with the determined mode.

18. The center fascia of claim 1, wherein the controller is further configured to determine a mode in accordance with a speed of a car having the center fascia installed therein and then display the screen in accordance with the determined mode.

19. The center fascia of claim 1, wherein the interface module is situated at either a top end or a bottom end of the screen, wherein an input for the specific portion of the interface module to face a specific direction is received, and wherein the controller is further configured to, if an additional content failing to appear on the screen is situated at an end portion of either the top end or the bottom end, display the additional content on the screen.

20. A method of controlling a center fascia, comprising:
receiving a user input from a user through an interface module; and
differently displaying a screen in accordance with at least one selected from the group consisting of a location of the interface module, a direction faced by a specific portion of the interface module and a touch input to the interface module,
wherein a category of the screen is moved from a first category to a second category different from the first category if receiving an input of moving the interface module in a first direction from the user,
wherein a menu of the category is moved to either a submenu or a supermenu if receiving a user input of moving the specific portion of the interface module in a second direction from the user
wherein the menu is moved from a first menu to a second menu different from the first menu if receiving a user input of moving the specific portion of the interface module in a third direction from the user, and
wherein a specific function of the menu is launched if receiving an input of pushing the interface module from the user.
